(19) United States
(12) Patent Application Publication
(10) Pub. No.: US 2009/0047886 A1
(43) Pub. Date: Feb. 19, 2009

(54) Cutlet cutter

(76) Inventor: John J. O'Neil, Mt. Olive Township, NJ (US)

Correspondence Address: THOMAS J. GERMINARIO, ESQ., 154 ROUTE 206, CHESTER, NJ, 07930, US

(21) Appl. No.: 11/889,918

(22) Filed: Aug. 17, 2007

(51) Int. Cl. A22C 17/02

(52) U.S. Cl. 452/160; 452/185

(57) ABSTRACT

A cutlet cutter cradles a slab of foodstock in a shallow bed within a horizontal surface along which the blade of a fillet knife can be moved. The slab of foodstock is secured and flattened from above by a presser, on which downward pressure is applied by a handle. Moving the knife along the horizontal surface causes the foodstock slab to be cross-sectionally cut into two fillets of consistent and uniform thickness. The presser keeps the operator's hand away from the knife's cutting edge, while the guide pins prevent the blade from slipping out of the horizontal surface.

### BACKGROUND OF THE INVENTION

The present invention relates to a device and method for preparing thin sections of food from a slab of foodstock. This invention is particularly suited to filleting boneless cuts of poultry, meat or fish to create thin cutlets. It specifically designed for household use, and accordingly is very simple, easy to use, durable, easy to clean, and inexpensive.

The present invention comprises two components. The first is a rectangular block-shaped cradle made of HDPE plastic. The cradle has a horizontal base and a horizontal surface that contains a shallow bed, which is an oblong cavity approximately ¼ inch deep. The shallow bed is offset toward one end of the horizontal base so as to form on either end a wide-side surface and a narrow-side surface. Four vertical guide pins protrude upward at the corners of the cradle. Preferably, the guide pins are also HDPE plastic integrally molded with the horizontal base of the cradle. The second component of this invention is a presser, also of HDPE plastic. The presser comprises a pad, which is rectangular in shape and has approximately the same dimensions as the cradle, and a handle that is attached to the pad. The handle preferably is integrally molded with the pad. The pad has four guide holes at its corners, through which the four guide pins of the cradle can be inserted.

The present invention is used by placing a slab of foodstock, such as a de-boned chicken breast, into the shallow bed of the cradle, fitting the apertures of the pad into the guide pins of the cradle, inserting a fillet knife between the pad and the cradle at the wide side surface, pressing down on the handle of the presser to flatten the breast and hold it in place, while running the knife along the horizontal surface of the cradle from the wide side surface to the narrow side surface. The two guide pins adjoining the narrow side surface prevent the knife from slipping out beyond the end of the cradle and causing injury.

The prior art in this field includes a number of devices designed to remove poultry or fish from the bone, but none specifically designed to fillet boneless poultry, meat or fish to create thin cutlets. Devices for slicing chicken breasts are disclosed in two patent application publications, Kidushim, et al., Pub. No. US2002/0151266, and Sverrison et al., Pub. No. US2006/0027060, but neither of these devices is structurally similar to the present invention, and both are primarily designed to remove the breast meat from the bone. Moreover, the Sverrison device is not suitable for household use.

More structurally similar to the present invention are several fish filleting devices, as taught by Engle, U.S. Pat. No. 2,913,760, Kuzio, U.S. Pat. Nos. 4,205,832 and 4,253,650, and Valleau, U.S. Pat. No. 4,815,169. Each of these devices comprises upper and lower blocks between which the fish is secured. Since fish filleting requires cutting around the spine, however, these devices feature intricate blade guides, which the present invention does not require. Moreover, all of these devices use a hinge to connect the two blocks. Such hinged structures are unsuitable for cutlet cutting, which requires even compression of the slab of foodstock in order to flatten it out so that uniform cross sections can be cut.

Some structural similarity to the present invention also appears in a bagel cutter invention, Fiola, U.S. Pat. No. 7,007,583. But Fiola's hinged design is also unsuitable for cutlet cutting, due to its inability to apply an even compression to the foodstock.

Hence, there is no prior art equivalent of the present invention in terms of the mechanism of the guide posts in conjunction with the presser used to generate uniform compression across the length of the foodstock slab so as to obtain two cutlets of uniform thickness. The prior-art devices are all designed to simply hold the poultry or fish in place while it is being cut. This is also true of the Fiola bagel cutter, which has a hinged design.

The present invention also has the advantage of simplicity and economy as compared with the prior art, thus making it more suitable for household use.

### SUMMARY OF THE INVENTION

An object of the present invention is to provide a device and method for cutting a slab of foodstock into thin sections.

Another object of the present invention is to provide a device and method particularly suited for filleting boneless cuts of poultry, meat or fish to create thin cutlets.

A further object of the present invention is to provide a cutlet cutter which is structurally simple, easy to use, easy to clean, durable, inexpensive, and thus well suited to household use.

Yet another object of the present invention is to provide a cutlet cutter that not only holds a slab of foodstock for cutting, but also applies even compression across the length of the slab so as to flatten it and enable uniform cross-sectional cutting.

Yet a further object of the present invention is to provide a cutlet cutter that is safe to use by structuring the device to limit the path of the cutting implement and prevent user contact with the cutting edge.

These and other beneficial objects are achieved by providing a device and method that safely and precisely fillets a slabs of foodstock, such as a boneless chicken breast, into uniform cross-sections, approximately ¼ inch thick. In its preferred embodiment, the present invention is made of HDPE plastic that is non-absorbent, resistant to cracking, chipping and bending, and is dishwasher-safe.

The present invention cradles the slab of foodstock in a shallow bed within a horizontal surface along which the blade of a fillet knife can be moved. The slab of foodstock is secured and flattened from above by a presser, on which downward pressure is applied by a handle. Moving the knife along the horizontal surface causes the foodstock slab to be cross-sectionally cut into two fillets of consistent and uniform thickness. The presser keeps the operator's hand away from the knife's cutting edge, while the guide pins prevent the blade from slipping out of the horizontal surface.

### BRIEF DESCRIPTION OF THE DRAWINGS

FIG. 1 is a perspective view of the present invention.

FIGS. 2 through 5 are depictions of the method of using the present invention.

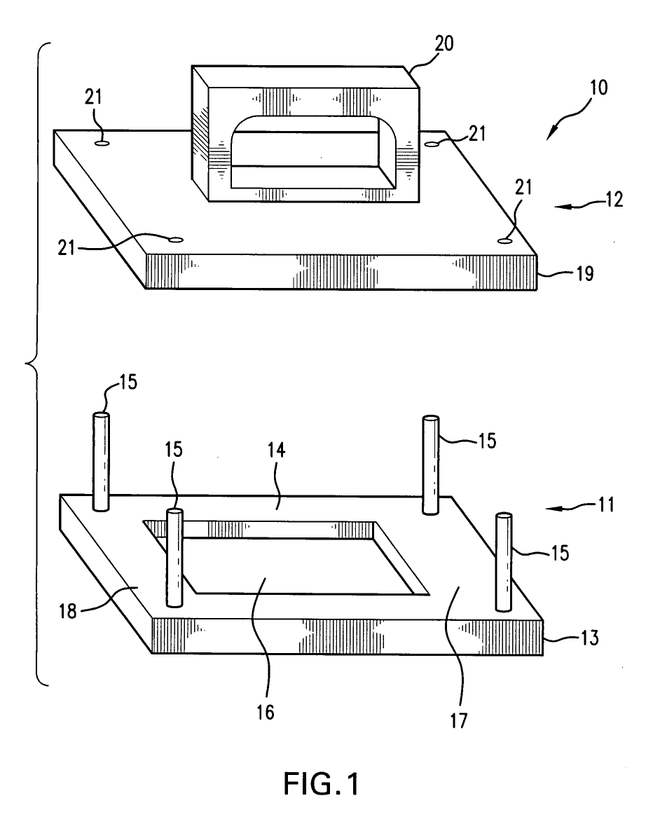

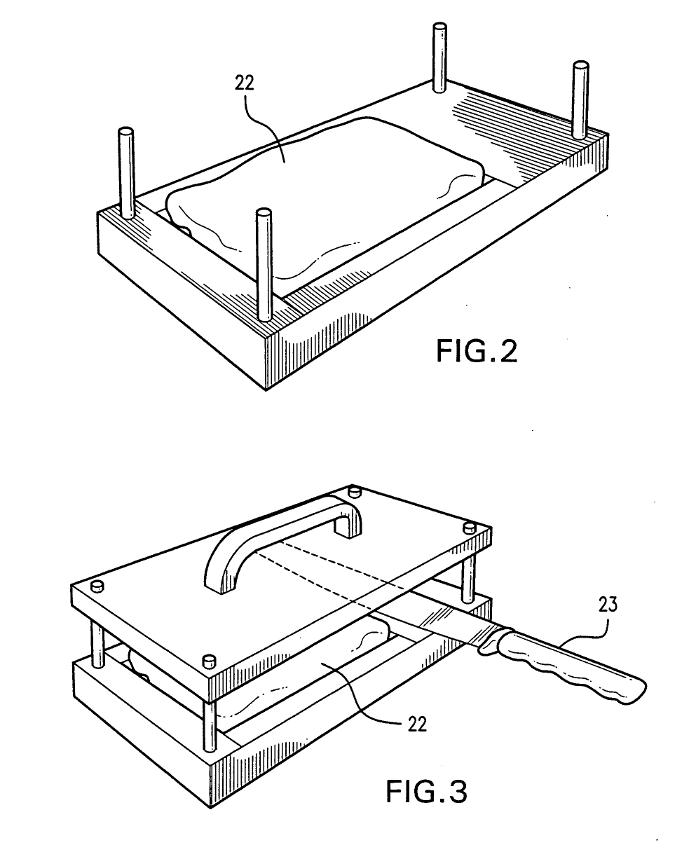

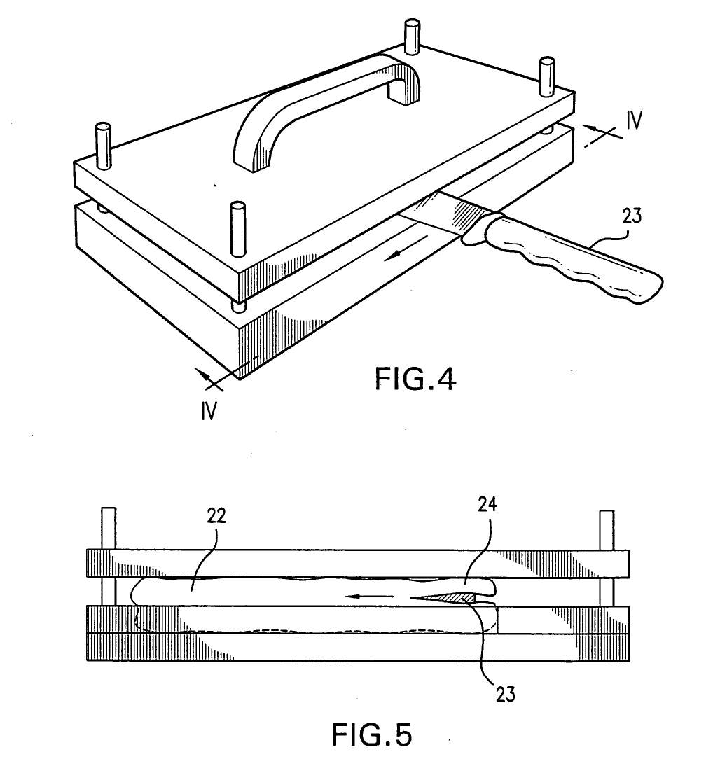

### DETAILED DESCRIPTION OF THE INVENTION

The present invention 10 comprises a cradle 11 and a presser 12. The cradle 11 is a rectangular block-shaped structure made of HDPE plastic. The cradle 11 comprises a horizontal base 13, a horizontal surface 14, and four guide pins 15. The horizontal surface 14 comprises a shallow bed 16, a wide-side surface 17, and a narrow-side surface 18. The shallow bed 16 is an oblong cavity approximately ¼ inch deep. The shallow bed 16 is offset toward one end of the horizontal base 13, so as to form on either end of the shallow bed the wide-side surface 17 and the narrow-side surface 18. The four vertical guide pins 15 protrude upward at the corners of the cradle 11. In the preferred embodiment 10, the guide pins 15 are HDPE plastic integrally molded with the horizontal base 13 of the cradle 11.

The second component of this invention 10 is the presser 12, also made of HDPE plastic. The presser comprises a pad 19 and a handle 20. The pad 19 is a rectangular panel-like structure, the lower face of which is congruent with the horizontal surface 14 of the cradle 11. The handle 20 is attached to the upper face of the pad 19. In the preferred embodiment 10, the handle 20 is HDPE plastic integrally molded with the pad 19. The pad 19 has at its four corners four guide holes 21, through which the four guide pins 15 of the cradle 11 can be inserted.

The present invention is used by placing a slab of foodstock 22, such as a de-boned chicken breast, into the shallow bed 16 of the cradle 11, fitting the guide holes 21 of the pad 19 into the guide pins 15 of the cradle 11, inserting a fillet knife 23 between the lower face of the pad 19 and the horizontal surface 14 of the cradle 11 at the wide side surface 17, pressing down on the handle 20 of the presser 12 to flatten the slab of foodstock 22 and hold it in place, while running the fillet knife 23 along the horizontal surface 14 of the cradle 11 from the wide-side surface 17 to the narrow-side surface 18, thereby making a lengthwise cross-sectional cut through the slab of foodstock 22 and evenly dividing it into two roughly equal fillets. The process is completed by lifting the presser 12 upward and disengaging it from the guide pins 15, and finally removing the fillets 24 from the shallow bed 16.

While this invention has been described with reference to a specific embodiment, the description is not to be construed in a limiting sense. Various modifications of the disclosed embodiment, as well as other embodiments of the invention, will be apparent to persons skilled in the art upon reference to this description. It is therefore contemplated that the appended claims will cover any such modifications or embodiments that fall within the true scope of this invention.

What is claimed is:

1. A cutlet cutter comprising:
(a) a cradle made of HDPE plastic, which cradle is a rectangular block-shaped structure with four corners, and which cradle comprises a horizontal base, a horizontal surface, and four vertical guide pins, such that the horizontal surface comprises a shallow bed, a wide-side surface, and a narrow-side surface, wherein the shallow bed is an oblong cavity that holds a slab of foodstock and that is offset toward one end of the horizontal base, so as to form at either end of the shallow bed the wide-side surface and the narrow-side surface, and such that the four vertical guide pins protrude upward from the four corners of the cradle; and
(b) a presser made of HDPE plastic, which presser comprises a pad and a handle, the pad being a rectangular panel-like structure and having a lower face, which is congruent with the horizontal surface of the cradle, and an upper face, to which the handle is attached, and the pad having four corners within which are four guide holes, through which the four guide pins of the cradle are slidably inserted, such that when downward pressure is applied to the handle, the presser slides downward along the guide pins until the lower face of the pad applies even compression across the length of the slab of foodstock so as to flatten the slab and enable the slab to be cut along a lengthwise cross-section into two roughly equal fillets by a fillet knife having a blade that is first inserted between the lower face of the pad and the wide-side surface and then is moved across the top of the shallow bed from the wide-side surface to the narrow side surface, where further movement of the blade is contained by two of the guide pins.

2. The cutlet cutter according to claim 1, wherein the guide pins are made of HDPE plastic.

3. The cutlet cutter according to claim 2, wherein the guide pins are integrally molded with the horizontal base of the cradle.

4. The cutlet cutter according to any of claims 1 through 3, wherein the handle is HDPE plastic and is integrally molded with the pad of the presser.

5. A method of cutting a slab of foodstock into fillets, comprising:
(a) providing a cutlet cutter comprising a presser and a cradle, such that the presser comprises a pad with four guide holes and a handle, and the cradle comprises a horizontal base, a horizontal surface and four vertical guide pins, and such that the horizontal surface comprises a shallow bed, a wide-side surface and a narrow-side surface and such that the four vertical guide pins protrude upward from the four corners of the cradle;
(b) placing a slab of foodstock into the shallow bed of the cradle;
(c) fitting the four guide pins of the cradle into the four guide holes of the pad and lowering the presser so that the bottom of the pad makes contact with the horizontal surface of the cradle;
(c) inserting a blade of a fillet knife between the pad of the presser and the horizontal surface of the cradle at the wide side surface;
(d) pressing down on the handle of the presser so as to hold the slab of foodstock in place and apply even compression across the length of the slab, thereby flattening the slab and enabling the slab to be cut uniformly along its lengthwise cross-section;
(e) running the blade of the fillet knife across the top of the shallow bed from the wide-side surface to the narrow-side surface, thereby making a lengthwise cross-sectional cut through the slab of foodstock and evenly dividing it into two roughly equal fillets;
(f) containing the slippage of the blade beyond the narrow-side surface by two of the guide pins obstructing such slippage;
(g) lifting the presser upward and disengaging it from the guide pins; and
(h) removing the fillets from the shallow bed.
